(19) United States
(12) Patent Application Publication
(10) Pub. No.: US 2026/0086577 A1
(43) Pub. Date: Mar. 26, 2026

(54) MOBILE ROBOT APPARATUS, SYSTEM, AND METHOD

(71) Applicant: INTEL CORPORATION, SANTA CLARA, CA (US)

(72) Inventors: Efraim Vitzrabin, Kiryat Ono (IL); Mark Vaynberg, Petah Tikva (IL); Dan Horovitz, Rishon Lezion (IL); Gregory Heifets, Rehovot (IL); Ben Rubovitch, Modi’in-Maccabim-Reut (IL)

(73) Assignee: INTEL CORPORATION, SANTA CLARA, CA (US)

(21) Appl. No.: 18/897,904

(22) Filed: Sep. 26, 2024

(51) Int. Cl. G05D 1/83; B60W 30/18; G05D 1/65

(52) U.S. Cl. CPC G05D 1/83; B60W 30/18109; G05D 1/65; B60W 2720/28

(57) ABSTRACT

For example, a controller of a mobile robot may be configured to generate a plurality of control outputs to control a plurality of actuators of a plurality of wheels of the mobile robot. For example, the controller may configure the plurality of control outputs to control deceleration of the mobile robot while maintaining a controlled trajectory of the mobile robot during a controlled safety stop. For example, during the controlled safety stop the controller may monitor rotational velocities of the plurality of wheels; and configure a first control output of the plurality of control outputs to control an actuator of a first wheel of the plurality of wheels based on a rotational velocity of the first wheel, a rotational velocity of a second wheel of the plurality of wheels, and a radius of the controlled trajectory.

### BACKGROUND

Mobile robots may include automatic machines, which may have the capability to move around in their environment.

In one example, a mobile robot may be implemented as an Automated Guided Vehicle (AGV), which may be configured to follow fixed paths or tracks, for example, for transportation of products.

In another example, a robot may be implemented as an Autonomous Mobile Robot (AMR), which may be configured to operate autonomously and to navigate in an uncontrolled environment, e.g., without the need for fixed paths or tracks.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a mobile robot, in accordance with some demonstrative aspects.

FIG. 2 is a schematic illustration of a rotational velocity profile corresponding to a first wheel of a mobile robot and a rotational velocity profile corresponding to a second wheel of the mobile robot, to illustrate one or more technical aspects, which may be handled in accordance with some demonstrative aspects.

FIG. 3 is a schematic illustration of a rotational velocity profile corresponding to a first wheel of a mobile robot and a rotational velocity profile corresponding to a second wheel of the mobile robot, in accordance with some demonstrative aspects.

FIG. 4 is a schematic illustration of a controller architecture, in accordance with some demonstrative aspects.

FIG. 5 is a schematic flow-chart illustration of a method of a mobile robot controlled safety-stop, in accordance with some demonstrative aspects.

FIG. 6 is a schematic illustration of a product of manufacture, in accordance with some demonstrative aspects.

### DETAILED DESCRIPTION

In the following detailed description, numerous specific details are set forth in order to provide a thorough understanding of some aspects. However, it will be understood by persons of ordinary skill in the art that some aspects may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

The words “exemplary” and “demonstrative” are used herein to mean “serving as an example, instance, demonstration, or illustration”. Any aspect, or design described herein as “exemplary” or “demonstrative” is not necessarily to be construed as preferred or advantageous over other aspects, or designs.

References to “one aspect”, “an aspect”, “demonstrative aspect”, “various aspects” etc., indicate that the aspect(s) so described may include a particular feature, structure, or characteristic, but not every aspect necessarily includes the particular feature, structure, or characteristic. Further, repeated use of the phrase “in one aspect” does not necessarily refer to the same aspect, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

The phrases “at least one” and “one or more” may be understood to include a numerical quantity greater than or equal to one, e.g., one, two, three, four, [ . . . ], etc. The phrase “at least one of” with regard to a group of elements may be used herein to mean at least one element from the group consisting of the elements. For example, the phrase “at least one of” with regard to a group of elements may be used herein to mean one of the listed elements, a plurality of one of the listed elements, a plurality of individual listed elements, or a plurality of a multiple of individual listed elements.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term “data”, however, is not limited to the aforementioned examples and may take various forms and/or may represent any information as understood in the art.

The terms “processor” or “controller” may be understood to include any kind of technological entity that allows handling of any suitable type of data and/or information. The data and/or information may be handled according to one or more specific functions executed by the processor or controller. Further, a processor or a controller may be understood as any kind of circuit, e.g., any kind of analog or digital circuit. A processor or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), and the like, or any combination thereof. Any other kind of implementation of the respective functions, which will be described below in further detail, may also be understood as a processor, controller, or logic circuit. It is understood that any two (or more) processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

The term “memory” is understood as a computer-readable medium (e.g., a non-transitory computer-readable medium) in which data or information can be stored for retrieval. References to “memory” may thus be understood as referring to volatile or non-volatile memory, including random access memory (RAM), read-only memory (ROM), flash memory, solid-state storage among others, or any combination thereof. Registers, shift registers, processor registers, data buffers, among others, are also embraced herein by the term memory. The term “software” may be used to refer to any type of executable instruction and/or logic, including firmware, which may be stored, for example, by a memory.

As used herein, the term “circuitry” may refer to, be part of, or include, an Application Specific Integrated Circuit (ASIC), an integrated circuit, an electronic circuit, a processor (shared, dedicated, or group), and/or memory (shared, dedicated, or group), that execute one or more software or firmware programs, a combinational logic circuit, and/or other suitable hardware components that provide the described functionality. In some aspects, some functions associated with the circuitry may be implemented by one or more software or firmware modules. In some aspects, circuitry may include logic, at least partially operable in hardware.

The term “logic” may refer, for example, to computing logic embedded in circuitry of a computing apparatus and/or computing logic stored in a memory of a computing apparatus. For example, the logic may be accessible by a processor of the computing apparatus to execute the computing logic to perform computing functions and/or operations. In one example, logic may be embedded in various types of memory and/or firmware, e.g., silicon blocks of various chips and/or processors. Logic may be included in, and/or implemented as part of, various circuitry, e.g., radio circuitry, receiver circuitry, control circuitry, transmitter circuitry, transceiver circuitry, processor circuitry, and/or the like. In one example, logic may be embedded in volatile memory and/or non-volatile memory, including random access memory, read only memory, programmable memory, magnetic memory, flash memory, persistent memory, and/or the like. Logic may be executed by one or more processors using memory, e.g., registers, buffers, stacks, and the like, coupled to the one or more processors, e.g., as necessary to execute the logic.

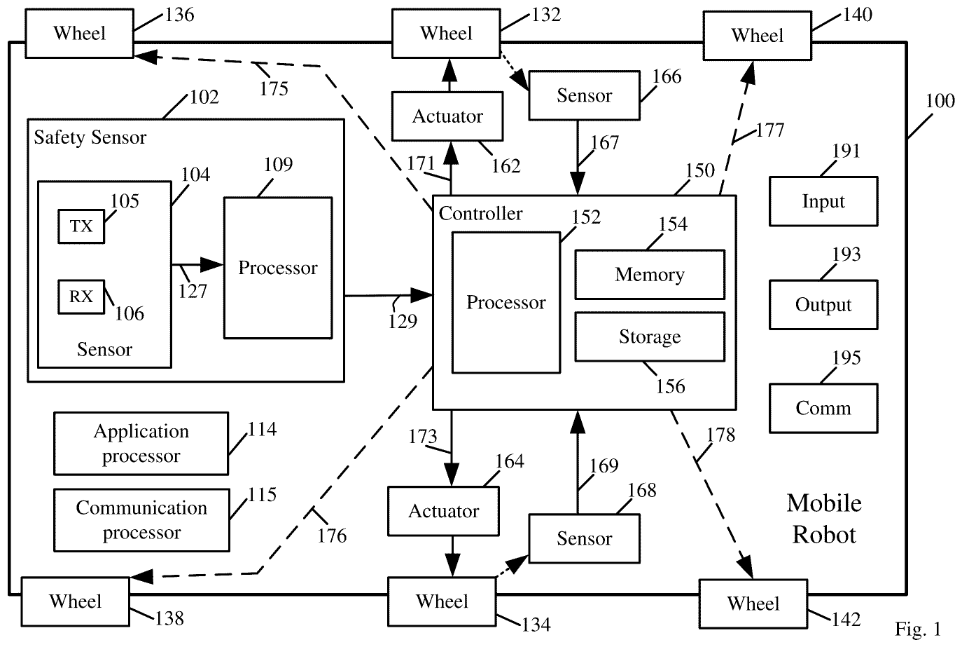

Reference is now made to FIG. 1, which schematically illustrates a mobile robot 100, in accordance with some demonstrative aspects.

In some demonstrative aspects, mobile robot 100 may be configured to carry one or more objects, e.g., from one place to another.

In other aspects, mobile robot 100 may be configured to perform one or more other additional or alternative operations and/or functionalities.

In some demonstrative aspects, the mobile robot 100 may include an Autonomous Mobile Robot (AMR), which may be configured to operate autonomously and to navigate in an uncontrolled environment, e.g., without the need for fixed paths or tracks.

In other aspects, the mobile robot 100 may include an Automated Guided Vehicle (AGV), which may be configured to follow fixed paths or tracks, for example, for transportation of products.

In other aspects, the mobile robot 100 may include any other suitable type of robot, which may have the capability to move around in an environment.

In some demonstrative aspects, mobile robot 100 may include at least one safety sensor 102, which may be configured to generate safety information 129, for example, during operation and/or movement of the mobile robot 100, e.g., as described below.

In some demonstrative aspects, the safety information 129 may include a safety event detection to indicate a safety event. In one example, safety sensor 102 may generate the safety information 129 including the safety event detection, for example, based on detection of a hazard, e.g., as described below.

In other aspects, the safety information 129 may include any other additional or alternative information.

In some demonstrative aspects, safety sensor 102 may include at least one sensor 104, which may be configured to provide sensor information 127 corresponding to the environment of the mobile robot 100.

In some demonstrative aspects, the at least one sensor 104 may include a light-based sensor 104, e.g., as described below.

In some demonstrative aspects, the light-based sensor 104 may include a Light Detection and Ranging (LiDAR) sensor.

In other aspects, the light-based sensor 104 may include any other additional type of light-based sensor configured to generate light-based sensor information based on sensed and/or detected light.

In some demonstrative aspects, as shown in FIG. 1, light-based sensor 104 may include a light transmitter (Tx) 105 and a light receiver (Rx) 106.

In some demonstrative aspects, light transmitter 105 may include one or more elements, for example, a light source, optic elements, and/or one or more other elements, configured to generate light signals to be emitted by the light-based sensor 104.

In some demonstrative aspects, safety sensor 102 may include a processor 109.

In some demonstrative aspects, processor 109 may include, or may be implemented, partially or entirely, by circuitry and/or logic, e.g., one or more processors including circuitry and/or logic, memory circuitry and/or logic. Additionally or alternatively, one or more functionalities of processor 109 may be implemented by logic, which may be executed by a machine and/or one or more processors, e.g., as described below.

In some demonstrative aspects, for example, processor 109 may provide digital transmit data values to the light-based sensor 104.

In some demonstrative aspects, light receiver 106 may include one or more elements, for example, one or more photo detectors, one or optical elements and/or one or more other elements, configured to detect and/or process, light signals received by light receiver 106.

In some demonstrative aspects, for example, light receiver 106 may be configured to convert a detected light signal into digital reception data values based on the detected light. For example, light-based sensor 104 may provide the sensor information 127 to the processor 109, for example, based on the digital reception data values.

In some demonstrative aspects, safety sensor 102 may include a light-based sensor 104, e.g., as described above.

In other aspects, safety sensor 102 may include any other additional or alternative type of sensor 104, e.g., instead of the light-based sensor, or in addition to the light-based sensor.

In one example, safety sensor 102 may include an image-based sensor 104, which may utilize one or more image-capturing devices, e.g., cameras. For example, the image-based sensor 104 may include one or more cameras, which may be configured to capture images from an environment of the mobile robot 100. For example, the image-based sensor 104 may be configured to provide the sensor information 127 to the processor 109, for example, based on the images captured by the cameras.

In another example, safety sensor 102 may include a radar-based sensor 104, which may utilize one or more radar devices. For example, the radar-based sensor 104 may include one or more radar transmitters 105, which may be configured to transmit radar signals, and one or more radar receivers 106, which may be configured to receive radar signals, for example, based on the transmitted radar signals. For example, the radar-based sensor 104 may be configured to provide the sensor information 127 to the processor 109, for example, based on the received radar signals.

In some demonstrative aspects, processor 109 may be configured to process the sensor information 127 from one or more sensos 104, for example, to detect one or more objects, e.g., in an environment of the mobile robot 100.

In one example, processor 109 may be configured to process the sensor information 127, for example, to detect the presence of one or more objects within a safety zone defined for the mobile robot 100.

In another example, processor 109 may be configured to process the sensor information 127, for example, to determine information including one or more of range, speed, direction, and/or any other information, of one or more objects, e.g., with respect to the mobile robot 100.

In some demonstrative aspects, processor 109 may be configured to determine the safety information 129, for example, based on the sensor information 127.

In some demonstrative aspects, processor 109 may be configured to monitor the sensor information 127, for example, to detect a hazard in an environment of the mobile robot 100, e.g., in a safety zone defined for the mobile robot 100, for example, during movement of the mobile robot 100.

In some demonstrative aspects, processor 109 may be configured to generate an alert, for example, based on a determination that the hazard is detected in the safety zone of the mobile robot 100. For example, processor 109 may be configured to provide the alert, for example, as part of, or in the form of, the safety information 129.

In some demonstrative aspects, mobile robot 100 may include a controller 150, which may be configured to control one or more elements and/or components of mobile robot 100, e.g., as described below.

In some demonstrative aspects, controller 150 may be configured to control rotation of a plurality of wheels of the mobile robot 100, e.g., as described below.

In some demonstrative aspects, controller 150 may be configured to generate a plurality of control outputs to control a plurality of actuators of the plurality of wheels of the mobile robot 100, e.g., as described below.

In some demonstrative aspects, mobile robot 100 may include at least two wheels, e.g., including a first wheel 132 and a second wheel 134.

In some demonstrative aspects, mobile robot 100 may include only two wheels, e.g., first wheel 132 and second wheel 134.

In some demonstrative aspects, mobile robot 100 may include more than two wheels, e.g., including the first wheel 132, the second wheel 134 and one or more additional wheels, e.g., one or more of a wheel 136, a wheel 138, a wheel 140, a wheel 142. For example, as shown in FIG. 1, mobile robot 100 may include two, three, four, five, or six wheels. In other aspects, mobile robot 100 may include any other suitable number of wheels.

In some demonstrative aspects, the plurality of wheels of mobile robot 100 may be positioned, for example, at a plurality of positions and/or according to an arrangement, which may be configured to support one or more maneuverability features, stability features, velocity features, payload features, and/or any other suitable additional or alternative features.

In other aspects, the plurality of wheels of mobile robot 100 may be positioned at any other locations and/or according to any other arrangement.

In some demonstrative aspects, controller 150 may be configured to generate a first control output 171 to control a first actuator 162 of the first wheel 132 of mobile robot 100, e.g., as described below.

For example, actuator 162 may include a motor, which may be driven by control output 171, e.g., to rotate the wheel 132.

In some demonstrative aspects, controller 150 may be configured to generate a second control output 173 to control a second actuator 164 of the second wheel 134 of mobile robot 100, e.g., as described below.

For example, actuator 164 may include a motor, which may be driven by control output 173, e.g., to rotate the wheel 134.

In some demonstrative aspects, controller 150 may be configured to generate one or more additional control outputs to control actuators of one or more additional wheels of the mobile robot 100.

For example, controller 150 may be configured to generate a control output 175 to control an actuator of wheel 136, a control output 176 to control an actuator of wheel 138, a control output 177 to control an actuator of wheel 140, and/or a control output 178 to control an actuator of wheel 142.

In some demonstrative aspects, controller 150 may be configured to generate control outputs to control rotation of each of the plurality of wheels of mobile robot 100. For example, mobile robot 100 may be configured to include actuators to rotate each of the plurality of wheels of mobile robot 100. According to this example, controller 150 may be configured to generate control outputs 171, 173, 175, 176, 177, and/or 178 to control the actuators of each of the plurality of wheels 132, 134, 136, 138, 140 and/or 142 of mobile robot 100.

In some demonstrative aspects, controller 150 may be configured to generate control outputs to control rotation of only some of the plurality of wheels of mobile robot 100. For example, some of the wheels of the mobile robot 100 may be configured as “active wheels”, which may be rotated by actuators, while one or more other wheels may be implemented as “passive wheels”, which may not be rotated by actuators.

In one example, one or more of the wheels of mobile robot may be implemented as “passive wheels”, for example, to maintain stability of the mobile robot, to support a payload of the mobile robot 100, or the like. According to this example, controller 150 may be configured to generate control outputs to control the actuators of the plurality of active wheels of mobile robot 100, e.g., at least wheel 132 and wheel 134.

In some demonstrative aspects, the plurality of actuators of the wheels of mobile robot 100, e.g., including actuator 162 and/or actuator 164, may include one or more motors, which may be driven by the control outputs of controller 150, e.g., control outputs 171, 173, 175, 176, 177, and/or 178, for example, to control, e.g., directly or indirectly, a motion of the mobile robot 100 in one or more Degrees of Freedom (DoF).

In some demonstrative aspects, controller 150 may include a safety Programable Logic Controller (PLC), a safety Micro Control Unit (MCU), a microprocessor, a Central Processing Unit (CPU), a Digital Signal Processor (DSP), a Field Programmable Gate Array (FPGA), an integrated circuit, an Application Specific Integrated Circuit (ASIC), and/or any other suitable type of controller.

In some demonstrative aspects, controller 150 may be implemented as part of a safety related system of mobile robot 100, e.g., together with safety sensor 102 and/or one or more additional or alternative safety components.

In some demonstrative aspects, controller 150 may include at least one processor 152, which may be configured to perform one or more operations and/or functionalities of controller 150, e.g., as described below.

In some demonstrative aspects, processor 152 may include an input to receive input information to be processed by processor 152, e.g., as described below. For example, the input of the processor 152 may include any suitable input interface, input unit, input module, input component, input circuitry, memory interface, memory access unit, memory reader, digital memory unit, bus interface, processor interface, or the like, which may be capable of receiving the input information to be processed by processor 152, e.g., from a memory, a processor, and/or any other suitable component to provide the input information to be processed by processor 152.

In some demonstrative aspects, processor 152 may include an output to provide output information processed by the processor 152, e.g., as described below. For example, the output of the processor 152 may include any suitable output interface, output unit, output module, output component, output circuitry, memory interface, memory access unit, memory writer, digital memory unit, bus interface, processor interface, or the like, which may be capable of outputting the output information from the processor 152 to a memory, a processor, and/or any other suitable component to handle the output information from the processor 152.

In some demonstrative aspects, controller 150 may include a storage 156 and/or a memory 154, e.g., to store information processed by controller 150, for example, safety information 129 from the safety processor 120, control information generated by the controller 150, and/or any other data generated by, and/or to be processed by, processor 152.

In some demonstrative aspects, mobile robot 100 may include, for example, an application processor 114 and/or a communication processor 115, for example, to at least partially implement one or more functionalities of controller 150 and/or to perform communication between controller 150, safety sensor 102, and/or one or more additional elements of mobile robot 100, and/or one or more other devices or systems.

In some demonstrative aspects, mobile robot 100 may include, for example, one or more input units, components, and/or devices 191, for example, sensors, encoders, switches, or the like.

In some demonstrative aspects, mobile robot 100 may include, for example, one or more communication units, components, and/or devices 195, for example, a serial communication interface, a parallel communication interface, a discrete communication interface, a wireless or communication interface, or the like.

In some demonstrative aspects, mobile robot 100 may include, for example, one or more output units, components, and/or devices 193, for example, a display, lights, audio transducers, or the like.

In some demonstrative aspects, controller 150 may be configured to control rotation of the plurality of wheels of mobile robot 100, e.g., wheels 132, 134, 136, 138, 140, and/or 142, for example, based on the safety information 129, e.g., as described below.

In some demonstrative aspects, controller 150 may be configured to generate the plurality of control outputs, e.g., including control output 171, control output 173, control output 175, control output 176, control output 177, and/or control output 178, for example, based on the safety information 129, e.g., as described below.

In some demonstrative aspects, controller 150 may be configured to generate the plurality of control outputs, e.g., including control output 171, control output 173, control output 175, control output 176, control output 177, and/or control output 178, for example, to control the plurality of actuators of the wheels of mobile robot 100, e.g., including actuator 162 and/or actuator 164, to control the speed of the one or more wheels of mobile robot 100, e.g., the wheels 132, 134, 136, 138, 140, and/or 140, e.g., as described below.

In one example, controller 150 may be configured to generate the control outputs 171, 173, 175, 176, 177 and/or 178, for example, to control a speed of the mobile robot 100, for example, based on whether or not an object is detected within a safety zone defined for the mobile robot 100.

For example, controller 150 may be configured to generate the control outputs 171, 173, 175, 176, 177 and/or 178, for example, to cause the mobile robot 100 to begin moving or to increase speed, for example, based on a determination that there is no object detected within the safety zone defined for the mobile robot 100.

For example, controller 150 may be configured to generate the control outputs 171, 173, 175, 176, 177 and/or 178, for example, to cause the mobile robot 100 to slow down, or to stop, for example, based on a determination that an object is detected within the safety zone defined for the mobile robot 100.

In some demonstrative aspects, controller 150 may be configured, for example, to configure the plurality of control outputs, e.g., the control outputs 171, 173, 175, 176, 177, and/or 178, for a controlled safety stop of the mobile robot 100, e.g., as described below.

In some demonstrative aspects, controller 150 may be configured to trigger the controlled safety stop of the mobile robot 100, for example, based on the safety information 129.

In some demonstrative aspects, controller 150 may be configured to trigger the controlled safety stop of the mobile robot 100, for example, based on a safety event detection, which may be based on the sensor information 127 from the one or more sensors 104 of the mobile robot 100.

For example, controller 150 may be configured to trigger the controlled safety stop of the mobile robot 100, for example, based on a safety event detection, which may be identified based on the safety information 129.

In one example, controller 150 may be configured to process the safety information 129 to identify a safety event detection, which may require a controlled safety stop of the mobile robot 100.

In some demonstrative aspects, controller 150 may be configured, for example, to configure the plurality of control outputs, e.g., the control outputs 171, 173, 175, 176, 177, and/or 178, to control deceleration of the mobile robot 100, for example, while maintaining a controlled trajectory of the mobile robot 100 during the controlled safety stop, e.g., as described below.

In some demonstrative aspects, the controller 150 may be configured, for example, to configure the plurality of control outputs, e.g., the control outputs 171, 173, 175, 176, 177, and/or 178, to provide a technical solution to support the controlled safety stop of the mobile robot 100, for example, in compliance with one or more functional safety requirements, for example, in accordance with a functional safety protocol or standard, e.g., as described below.

For example, the controller 150 may configure the plurality of control outputs, e.g., the control outputs 171, 173, 175, 176, 177, and/or 178, to provide a technical solution to support the controlled safety stop of the mobile robot 100, for example, in compliance with functional safety requirements of a functional safety protocol or standard for mobile robots, e.g., as described below.

In some demonstrative aspects, controller 150 may be configured to monitor the safety information 129 from one or more safety sensors 102, for example, in accordance with an applicable functional safety standard or protocol, e.g., as described below.

In some demonstrative aspects, the controller 150 may configure the plurality of control outputs, e.g., the control outputs 171, 173, 175, 176, 177, and/or 178, for example, to perform a controlled safety stop, for example, in case of detection of an abnormal behavior, e.g., which may be defined according to the applicable functional safety standard and/or according to any other criteria, e.g., as described below.

In some demonstrative aspects, the controller 150 may configure the plurality of control outputs, e.g., the control outputs 171, 173, 175, 176, 177, and/or 178, for example, to control a velocity vector of the mobile robot 100, for example, to follow a deliberately selected path (controlled trajectory), e.g., as described below.

In one example, the controlled trajectory may include a predefined trajectory.

In another example, the controlled trajectory may include a most recent trajectory of the mobile robot, e.g., according to a latest available input.

In another example, the controlled trajectory may include a real-time adjusted trajectory, which may be adjusted, for example, based on sensor information from the sensors 104, and/or programmed logic.

In another example, the controlled trajectory may include any other suitable path, which may be defined, for example, by a user, a manufacturer, an administrator, or the like.

In some demonstrative aspects, controller 150 may be configured, for example, to configure the plurality of control outputs, e.g., the control outputs 171, 173, 175, 176, 177, and/or 178, for example, to control a category 1 deceleration-controlled safety stop (SS1-d) of mobile robot 100, e.g., as described below.

In some demonstrative aspects, controller 150 may be configured, for example, to configure the plurality of control outputs, e.g., the control outputs 171, 173, 175, 176, 177, and/or 178, for example, to control a safety stop of mobile robot 100 according to an SS1-d function, for example, in compliance with one or more International Electrotechnical Commission (IEC) standards, e.g., including IEC 61800 May 2 (“IEC 61800 May 2:2016, Adjustable speed electrical power drive systems-Part 5-2: Safety requirements-Functional”, 2016); in compliance with one or more International Organization for Standardization (ISO) standards, e.g., including ISO3691-4:2023 (“ISO 3691-4:2023, Industrial trucks-Safety requirements and verification, Part 4: Driverless industrial trucks and their systems, Published (Edition 2, 2023)”); and/or in compliance with one or more American National Standards Institute (ANSI) standards, e.g., including ANSI R15.08 (“ANSI A3 R15.08-2-2023 American National Standard for Industrial Mobile Robots-Safety Requirements-Part 2: Requirements for IMR system(s) and IMR application(s) (PDF)”).

In some demonstrative aspects, controller 150 may be configured, for example, to configure the plurality of control outputs, e.g., the control outputs 171, 173, 175, 176, 177, and/or 178, for example, to cause mobile robot 100 to decelerate to a halt, for example, according to a deceleration profile that satisfies requirements of a functional safety standard, for example, for a controlled safety stop, e.g., SS1-d, a category 2 deceleration-controlled safety stop (SS2-d), or the like.

For example, a category 0 stop may include an uncontrolled stop, where the power to a motor may be safely removed, e.g., immediately, for example, through a mechanical disconnection of the motor and, if necessary, breaking. In one example, the category 0 safety stop may be implemented by a Safe Torque Off (STO) function.

For example, a category 0 stop may not be suitable for many safety applications, e.g., for a safety stop of a mobile robot.

For example, a category 1 safety stop (SS1) may include a controlled stop, where the power of a motor is made available to the motor to achieve the stop. For example, the power may be moved from the motor, e.g., when the stop is achieved. In one example, the controlled stop may utilize an SS1 function to cause a rapid and safe stopping of a drive, for example, by controlling the drive to decelerate autonomously.

For example, a category 1 deceleration-controlled safety stop (SS1-d) may utilize an SS1-d function to initiate and control the motor deceleration rate within set limits to stop the motor. For example, the SS1-d function may initiate the STO function when the motor speed is below a specified limit.

For example, a category 1 ramp-monitored safety stop (SS1-r) may utilize an SS1-r function to initiate and monitor the motor deceleration rate within set limits to stop the motor. For example, the SS1-r function may initiate the STO function when the motor speed is below a specified limit.

For example, a category 1 time-controlled safety stop (SS1-t) may utilize an SS1-t function to initiate the motor deceleration, and to initiate the STO function after an application specific time delay.

In other aspects, controller 150 may be configured, for example, to configure the plurality of control outputs, e.g., the control outputs 171, 173, 175, 176, 177, and/or 178, for example, to control an SS1-r stop, an SS1-t stop, and/or any other suitable additional or alternative type of controlled safety stop.

In some demonstrative aspects, controller 150 may be configured, for example, to configure the plurality of control outputs, e.g., the control outputs 171, 173, 175, 176, 177, and/or 178, to provide a technical solution to support the controlled safety stop of the mobile robot 100, for example, instead of performing a non-controlled stop, for example, an STO, e.g., as described below.

For example, applying the STO to a mobile robot may freeze the actuators of the wheels of the mobile robot, in a manner which may be intended to cause an immediate stop as soon as possible. However, the STO may result in one or more technical problems, e.g., in some use cases and/or scenarios.

In one example, in case of a relatively high velocity of the mobile robot, the STO may cause a very sharp deceleration, which may result in damage to a payload carried by the mobile robot.

In another example, in case of a relatively high velocity of the mobile robot, the STO may cause a hard stop of the wheels of the mobile robot, which may result in a skid motion, e.g., an uncontrolled skid, which may not be allowed according to functional safety requirements.

In some demonstrative aspects, controller 150 may be configured, for example, to configure the plurality of control outputs, e.g., the control outputs 171, 173, 175, 176, 177, and/or 178, to provide a technical solution to support the controlled safety stop of the mobile robot 100, for example, with a reduced possibility of skidding.

In some demonstrative aspects, controller 150 may be configured, for example, to configure the plurality of control outputs, e.g., the control outputs 171, 173, 175, 176, 177, and/or 178, to provide a technical solution to support the controlled safety stop of the mobile robot 100, for example, while maintaining a controlled trajectory of the mobile robot 100, e.g., as described below.

For example, a mobile robot, e.g., mobile robot 100, may utilize wheel actuators, e.g., actuator 162 and actuator 164, which may be configured to be in charge of both controlling a forward movement of the mobile robot, as well as controlling a turning direction of the mobile robot.

For example, this configuration of a mobile robot may be different from a configuration of other types of mobile systems, e.g., cars, which may utilize a set of wheels, e.g., front wheels, which may be dedicated for controlling the turning direction.

In one example, in opposed to the mobile robot, the stopping of the car may be controlled by applying brakes to the back wheels, while using the front wheels to control the turning direction of the car.

In some demonstrative aspects, controller 150 may be configured, for example, to configure the plurality of control outputs, e.g., the control outputs 171, 173, 175, 176, 177, and/or 178, to provide a technical solution to maintain the controlled trajectory of the mobile robot 100 during the controlled safety stop, e.g., as described below.

In some demonstrative aspects, controller 150 may be configured, for example, to configure the plurality of control outputs, e.g., the control outputs 171, 173, 175, 176, 177, and/or 178, to provide a technical solution to maintain a driving radius of the mobile robot 100 during the controlled safety stop, e.g., as described below.

For example, in some use cases and/or scenarios, the ability to maintain the driving radius of the mobile robot 100 during the controlled safety stop may be of high importance, e.g., in order to avoid collisions with nearby entities, e.g., humans or obstacles, during the controlled safety stop.

In some demonstrative aspects, controller 150 may be configured, for example, to configure the plurality of control outputs, e.g., the control outputs 171, 173, 175, 176, 177, and/or 178, to provide a technical solution to control the rotational velocities of the wheels of the mobile robot 100, for example, in order to maintain the controlled trajectory of the mobile robot 100 during the controlled safety stop, e.g., as described below.

In some demonstrative aspects, controller 150 may be configured, for example, to configure the plurality of control outputs, e.g., the control outputs 171, 173, 175, 176, 177, and/or 178, according to an electrical breaking-based motor control mechanism, which may be configured to control deceleration of the mobile robot 100 by controlling the rotational velocities of the wheels of the mobile robot 100 during the controlled safety stop, e.g., as described below.

In some demonstrative aspects, controller 150 may be configured, for example, to configure the plurality of control outputs, e.g., the control outputs 171, 173, 175, 176, 177, and/or 178, according to an electrical breaking-based motor control mechanism, which may be configured to control deceleration of the mobile robot 100, while maintaining the controlled trajectory of the mobile robot 100 during the controlled safety stop, e.g., as described below.

In some demonstrative aspects, controller 150 may be configured, for example, to configure the plurality of control outputs, e.g., the control outputs 171, 173, 175, 176, 177, and/or 178, according to an electrical breaking-based motor control mechanism, which may be configured to take into consideration a multi-wheel dependency between the rotational velocities of the plurality of wheels of the mobile robot 100 during the controlled safety stop, e.g., as described below.

In some demonstrative aspects, the electrical breaking-based motor control mechanism may be utilized to provide a technical solution to support an improved safety function, which may support, for example, increased velocities of the mobile robot 100, e.g., velocities of 2.4 meter per second (m/sec) and above.

For example, the electrical breaking-based motor control mechanism may be utilized to provide a technical solution to support a controlled safety stop according to at least an SS1 function with respect to both linear trajectories as well as non-linear trajectories, which may be required, for example, to safety-certify mobile robots operating at high speeds.

In some demonstrative aspects, controller 150 may be configured, for example, to configure the plurality of control outputs, e.g., the control outputs 171, 173, 175, 176, 177, and/or 178, to provide a technical solution to support a controlled safety stop of a mobile robot, e.g., mobile robot 100, including two or more wheels, e.g., wheels 132 and 134, which may be dependent on each other, or mutually coupled, with respect to an effect on the trajectory of the mobile robot during a safety stop, e.g., as described below.

In some demonstrative aspects, controller 150 may be configured, for example, to configure the plurality of control outputs, e.g., the control outputs 171, 173, 175, 176, 177, and/or 178, to provide a technical solution to support a controlled safety stop of mobile robot 100 with respect to a linear trajectory and/or a nonlinear trajectory, e.g., as described below.

In some demonstrative aspects, controller 150 may be configured, for example, to configure the plurality of control outputs, e.g., the control outputs 171, 173, 175, 176, 177, and/or 178, to provide a technical solution to support a mobile robot, e.g., mobile robot 100, which is certifiable according to SS1-d functional safety requirements, SS1-r functional safety requirements, and/or SS1-t functional safety requirements.

In some demonstrative aspects, controller 150 may be configured, for example, to configure the plurality of control outputs, e.g., the control outputs 171, 173, 175, 176, 177, and/or 178, to provide a technical solution to support the mobile robot 100 in preserving a system radius movement during the safety stop, e.g., as an addition to SS1-d functional safety requirements.

In some demonstrative aspects, controller 150 may be configured to monitor rotational velocities of the plurality of wheels of the mobile robot 100, for example, during a controlled safety stop of mobile robot 100, e.g., as described below.

For example, controller 150 may be configured to monitor rotational velocities of the wheel 132 and the wheel 134, for example, during the controlled safety stop of mobile robot 100, e.g., as described below.

In some demonstrative aspects, controller 150 may be configured to monitor the rotational velocities of the plurality of wheels of the mobile robot 100, for example, based on velocity information from one or more sensors, e.g., as described below.

In some demonstrative aspects, mobile robot 100 may include a plurality of velocity sensors to sense the rotational velocities of the plurality of wheels of mobile robot 100, and to generate velocity information based on the rotational velocities of the plurality of wheels of mobile robot 100.

In some demonstrative aspects, mobile robot 100 may include a plurality of velocity sensors to sense the rotational velocities of the plurality of active wheels of mobile robot 100. In one example, mobile robot 100 may include a velocity sensor per active wheel.

For example, a velocity sensor corresponding to a wheel, e.g., an active wheel, may be configured to provide velocity information based on the rotational velocity of the wheel.

In some demonstrative aspects, as shown in FIG. 1, mobile robot 100 may include a first velocity sensor 166, which may be configured to sense the rotational velocity of wheel 132, and to provide velocity information 167 based on the sensed velocity of the wheel 132.

In some demonstrative aspects, as shown in FIG. 1, mobile robot 100 may include a second velocity sensor 168, which may be configured to sense the rotational velocity of wheel 134, and to provide velocity information 169 based on the sensed velocity of the wheel 134.

In some demonstrative aspects, mobile robot 100 may include one or more additional or alternative velocity sensors, which may be configured to sense the rotational velocity of one or more other wheels of mobile robot, e.g., wheel 136, wheel 138, wheel 140, and/or wheel 142.

In some demonstrative aspects, controller 150 may be configured to receive the velocity information from the plurality of velocity sensors, and to monitor the rotational velocities of the plurality of wheels based on the velocity information from the plurality of velocity sensors, e.g., as described below.

In some demonstrative aspects, as shown in FIG. 1, controller 150 may be configured to receive the velocity information 167 from the sensor 166, and to monitor the rotational velocity of the wheel 132, for example, based on the velocity information 167.

In some demonstrative aspects, as shown in FIG. 1, controller 150 may be configured to receive the velocity information 169 from the sensor 168, and to monitor the rotational velocity of the wheel 134, for example, based on the velocity information 169.

In some demonstrative aspects, controller 150 may be configured, for example, to configure the plurality of control outputs, e.g., the control outputs 171, 173, 175, 176, 177, and/or 178, to control the plurality of actuators of the mobile robot 100, for example, based on the rotational velocities of the plurality of wheels, for example, during the controlled safety stop, e.g., as described below.

In some demonstrative aspects, controller 150 may be configured, for example, to configure the plurality of control outputs, e.g., the control outputs 171, 173, 175, 176, 177, and/or 178, to control the plurality of actuators of the mobile robot 100, for example, based on a radius of the controlled trajectory of the mobile robot to be maintained during the controlled safety stop, e.g., as described below.

In some demonstrative aspects, controller 150 may be configured, for example, to configure a control output to control an actuator of a wheel of the mobile robot 100, for example, based on the rotational velocity of the wheel and one or more rotational velocities of one or more other wheels of the mobile robot, for example, during the controlled safety stop, e.g., as described below.

In some demonstrative aspects, controller 150 may be configured, for example, to configure the control output to control the actuator of the wheel of the mobile robot 100, for example, based on the radius of the controlled trajectory of the mobile robot 100 to be maintained during the controlled safety stop, e.g., as described below.

In some demonstrative aspects, controller 150 may be configured, for example, to configure the control output 171, for example, during the controlled safety stop, to control the actuator 162 of the first wheel 132, for example, based on a rotational velocity of the first wheel 132, a rotational velocity of a second wheel of the plurality of wheels, e.g., the wheel 134, and the radius of the controlled trajectory of the mobile robot 100 to be maintained during the controlled safety stop, e.g., as described below.

In some demonstrative aspects, controller 150 may be configured, for example, to configure the control output 173, for example, during the controlled safety stop, to control the actuator 164 of the second wheel 134, for example, based on a rotational velocity of the first wheel 132, the rotational velocity of the second wheel 134, and the radius of the controlled trajectory of the mobile robot 100 to be maintained during the controlled safety stop, e.g., as described below.

In some demonstrative aspects, controller 150 may be configured, for example, to configure the control output 171 for wheel 132 and/or the control output 173 for wheel 134 during the controlled safety stop, for example, based on a rotational velocity of at least a third wheel, e.g., as described below.

In one example, controller 150 may be configured, for example, to configure the control output 171 for wheel 132 and the control output 173 for wheel 134 during the controlled safety stop, for example, based on a rotational velocity of at least one same additional wheel.

For example, controller 150 may configure the control output 171 for wheel 132 and the control output 173 for wheel 134 during the controlled safety stop, for example, based on a rotational velocity of wheel 136.

In another example, controller 150 may be configured, for example, to configure the control output 171 for wheel 132 and the control output 173 for wheel 134 during the controlled safety stop, for example, based on rotational velocities of different additional wheels.

For example, controller 150 may configure the control output 171 for wheel 132 during the controlled safety stop, for example, based on a rotational velocity of wheel 136; and/or to configure the control output 173 for wheel 134 during the controlled safety stop, for example, based on a rotational velocity of wheel 138.

In some demonstrative aspects, controller 150 may be configured, for example, to configure the plurality of control outputs, e.g., the control outputs 171, 173, 175, 176, 177, and/or 178, for example, to maintain the controlled trajectory of the mobile robot 100 during the controlled safety stop to be substantially constant, e.g., as described below.

In some demonstrative aspects, controller 150 may be configured to determine the radius of the controlled trajectory of the mobile robot 100 to be maintained during the controlled safety stop, for example, based on a radius of a trajectory of the mobile robot 100 prior to the controlled safety stop, e.g., as described below.

In some demonstrative aspects, controller 150 may be configured, for example, to configure the plurality of control outputs, e.g., the control outputs 171, 173, 175, 176, 177, and/or 178, for example, to maintain the controlled trajectory of the mobile robot 100 during the controlled safety stop to be substantially constant and substantially equal, for example, to the radius of the trajectory of the mobile robot 100 prior to the controlled safety stop, e.g., as described below.

In some demonstrative aspects, controller 150 may be configured to determine the radius of the controlled trajectory of the mobile robot 100 to be maintained during the controlled safety stop, for example, according to a predefined radius for the controlled safety stop, e.g., as described below.

In some demonstrative aspects, controller 150 may be configured, for example, to configure the plurality of control outputs, e.g., the control outputs 171, 173, 175, 176, 177, and/or 178, for example, to maintain the controlled trajectory of the mobile robot 100 during the controlled safety stop to be substantially constant and substantially equal, for example, to the predefined radius for the controlled safety stop, e.g., as described below.

In some demonstrative aspects, controller 150 may be configured to determine the radius of the controlled trajectory of the mobile robot 100 to be maintained during the controlled safety stop, for example, based on a radius of a predefined trajectory for the controlled safety stop, e.g., as described below.

In some demonstrative aspects, controller 150 may be configured, for example, to configure the plurality of control outputs, e.g., the control outputs 171, 173, 175, 176, 177, and/or 178, for example, such that the mobile robot 100 is to substantially follow the predefined trajectory during the controlled safety stop, e.g., as described below.

In other aspects, controller 150 may be configured to determine the radius of the controlled trajectory of the mobile robot 100 to be maintained during the controlled safety stop, for example, based on any other additional or alternative parameter, input and/or criteria.

In some demonstrative aspects, controller 150 may be configured, for example, to configure the plurality of control outputs, e.g., the control outputs 171, 173, 175, 176, 177, and/or 178, for example, based on a monitored trajectory radius of the mobile robot during the controlled safety stop, e.g., as described below.

In some demonstrative aspects, the monitored trajectory radius of the mobile robot 100 may be based, for example, on the rotational velocity of the plurality of wheels of the mobile robot 100, for example, the rotational velocity of wheel 132, the rotational velocity of wheel 134, the rotational velocity of wheel 136, the rotational velocity of wheel 138, the rotational velocity of wheel 140, and/or the rotational velocity of wheel 142, e.g., as described below.

For example, controller 150 may be configured to determine the monitored trajectory radius of the mobile robot 100 during the controlled safety stop, and to configure the plurality of control outputs, e.g., the control outputs 171, 173, 175, 176, 177, and/or 178, for example, based on a monitored trajectory radius of the mobile robot 100 during the controlled safety stop, e.g., as described below.

In some demonstrative aspects, controller 150 may be configured, for example, to configure the first control output 171 and the second control output 173, for example, based on the monitored trajectory radius of the mobile robot 100, which may be based, for example, on the rotational velocity of the first wheel 132 and the rotational velocity of the second wheel 134, e.g., as described below.

In some demonstrative aspects, controller 150 may be configured, for example, to configure the plurality of control outputs, e.g., the control outputs 171, 173, 175, 176, 177, and/or 178, for example, based on a difference between the radius of the controlled trajectory of the mobile robot 100 and the monitored trajectory radius of the mobile robot 100, e.g., as described below.

In some demonstrative aspects, controller 150 may be configured, for example, to configure the first control output 171 and the second control output 173, for example, based on the difference between the radius of the controlled trajectory of the mobile robot 100 and the monitored trajectory radius of the mobile robot 100, e.g., as described below.

In some demonstrative aspects, controller 150 may be configured to determine the monitored trajectory radius of the mobile robot 100, for example, based on a ratio between a linear velocity sum and a linear velocity difference, e.g., as described below.

In some demonstrative aspects, the linear velocity sum may include a sum of a linear velocity of the first wheel 132 and a linear velocity of the second wheel 134, e.g., as described below.

In some demonstrative aspects, the linear velocity difference may include a difference between the linear velocity of the first wheel 132 and the linear velocity of the second wheel 134, e.g., as described below.

In some demonstrative aspects, controller 150 may be configured to determine the linear velocity of the first wheel 132, for example, based on the rotational velocity of the first wheel 132, e.g., as described below.

In some demonstrative aspects, controller 150 may be configured to determine the linear velocity of the second wheel 134, for example, based on the rotational velocity of the second wheel 134, e.g., as described below.

In other aspects, controller 150 may be configured to determine the monitored trajectory radius of the mobile robot 100 based on any other additional or alternative input, parameters, and/or calculations.

In some demonstrative aspects, controller 150 may be configured, for example, to configure the plurality of control outputs, e.g., the control outputs 171, 173, 175, 176, 177, and/or 178, for example, according to a plurality of rotational velocity profiles corresponding to the plurality of wheels of mobile robot 100, e.g., as described below.

In some demonstrative aspects, the plurality of rotational velocity profiles may be configured, for example, to maintain the controlled trajectory of the mobile robot 100 during the controlled safety stop, e.g., as described below.

In some demonstrative aspects, the plurality of rotational velocity profiles may include at least one set of mutually-coupled rotational velocity profiles, e.g., as described below.

In some demonstrative aspects, the set of mutually-coupled rotational velocity profiles may include two or more rotational velocity profiles, which may be mutually coupled, e.g., as described below.

In some demonstrative aspects, the set of mutually-coupled rotational velocity profiles may include a first rotational velocity profile corresponding to a first wheel, which may be mutually coupled with a second rotational velocity profile corresponding to a second wheel, e.g., as described below.

In some demonstrative aspects, the first rotational velocity profile may be coupled to, affected by, and/or dependent on, the second rotational velocity profile, e.g., as described below.

In some demonstrative aspects, the second rotational velocity profile may be coupled to, affected by, and/or dependent on, the first rotational velocity profile, e.g., as described below.

In some demonstrative aspects, controller 150 may be configured, for example, to configure the first control output 171 to control the rotational velocity of the first wheel 132, for example, according to a first rotational velocity profile, e.g., as described below.

In some demonstrative aspects, controller 150 may be configured, for example, to configure the second control output 173 to control the rotational velocity of the second wheel 134, for example, according to a second rotational velocity profile, e.g., as described below.

In some demonstrative aspects, the first rotational velocity profile and the second rotational velocity profile may be configured, for example, to maintain the controlled trajectory of the mobile robot 100 during the controlled safety stop, e.g., as described below.

In some demonstrative aspects, the first rotational velocity profile for the first wheel 132 may be non-linear, e.g., as described below.

In some demonstrative aspects, the second rotational velocity profile for the second wheel 134 may be non-linear, e.g., as described below.

In other aspects, the first rotational velocity profile for the first wheel 132 and/or the second rotational velocity profile for the second wheel 134 may be substantially linear.

In some demonstrative aspects, the first rotational velocity profile for the first wheel 132 may be different from the second rotational velocity profile for the second wheel 134, e.g., as described below.

In other aspects, the first rotational velocity profile for the first wheel 132 may be substantially similar to the second rotational velocity profile for the second wheel 134.

In some demonstrative aspects, controller 150 may be configured, for example, to configure a rotational velocity profile for a wheel, for example, to be between an upper bound for the rotational velocity profile and a lower bound for the rotational velocity profile, e.g., as described below.

In some demonstrative aspects, the upper bound for the rotational velocity profile may be monotonously decreasing between a first time of the controlled safety stop and a second time of the controlled safety stop, e.g., as described below.

In some demonstrative aspects, controller 150 may be configured, for example, to adjust the lower bound for the rotational velocity profile, for example, based on the rotational velocity of at least one other wheel of the mobile robot 100, e.g., as described below.

In some demonstrative aspects, controller 150 may be configured, for example, to configure the first rotational velocity profile for the first wheel 132, for example, to be between an upper bound for the first rotational velocity profile and a lower bound for the first rotational velocity profile, e.g., as described below.

In some demonstrative aspects, the upper bound for first rotational velocity profile for the first wheel 132 may be monotonously decreasing from a first time of the controlled safety stop to a second time of the controlled safety stop, e.g., as described below.

In some demonstrative aspects, controller 150 may be configured to adjust the lower bound for the first rotational velocity profile for the first wheel 132 between the first time and the second time, for example, based on the rotational velocity of the second wheel 134, e.g., as described below.

In some demonstrative aspects, controller 150 may be configured, for example, to configure the second rotational velocity profile for the second wheel 134, for example, to be between an upper bound for the second rotational velocity profile and a lower bound for the second rotational velocity profile, e.g., as described below.

In some demonstrative aspects, the upper bound for second rotational velocity profile for the second wheel 134 may be monotonously decreasing from the first time of the controlled safety stop to the second time of the controlled safety stop, e.g., as described below.

In some demonstrative aspects, controller 150 may be configured to adjust the lower bound for the second rotational velocity profile for the second wheel 134 between the first time and the second time, for example, based on the rotational velocity of the first wheel 132, e.g., as described below.

In some demonstrative aspects, controller 150 may be configured to adjust a control output of the plurality of control outputs, e.g., the control outputs 171, 173, 175, 176, 177, and/or 178, for example, based on a first adjustment, which is based on a rotational velocity of a wheel to be controlled by the control output, and based on a second adjustment, which is based on a rotational velocity of at least one other wheel, e.g., as described below.

In some demonstrative aspects, the second adjustment corresponding to the wheel may be based on the rotational velocity of the at least one other wheel, and the rotational velocity of the wheel, e.g., as described below.

In some demonstrative aspects, the second adjustment corresponding to the wheel may be based on the rotational velocity of the wheel, the rotational velocity of the at least one other wheel, and the radius of the controlled trajectory to be maintained during the controlled safety stop of the mobile robot 100, e.g., as described below.

In some demonstrative aspects, controller 150 may be configured to determine a first first-wheel adjustment corresponding to the first wheel 132, for example, based on the rotational velocity of the first wheel 132, e.g., as described below.

In some demonstrative aspects, controller 150 may be configured to determine a second first-wheel adjustment corresponding to the first wheel 132, for example, based on the rotational velocity of the first wheel 132, the rotational velocity of the second wheel 134, and the radius of the controlled trajectory to be maintained during the controlled safety stop of the mobile robot 100, e.g., as described below.

In some demonstrative aspects, controller 150 may be configured to adjust the first control output 171, for example, based on the first first-wheel adjustment corresponding to the first wheel 132, and the second first-wheel adjustment corresponding to the first wheel 132, e.g., as described below.

In some demonstrative aspects, controller 150 may be configured to determine a first second-wheel adjustment corresponding to the second wheel 134, for example, based on the rotational velocity of the second wheel 134, e.g., as described below.

In some demonstrative aspects, controller 150 may be configured to determine a second second-wheel adjustment corresponding to the second wheel 134, for example, based on the rotational velocity of the first wheel 132, the rotational velocity of the second wheel 134, and the radius of the controlled trajectory to be maintained during the controlled safety stop of the mobile robot 100, e.g., as described below.

In some demonstrative aspects, controller 150 may be configured to adjust the second control output 173, for example, based on the first second-wheel adjustment corresponding to the second wheel 134, and the second second-wheel adjustment corresponding to the second wheel 134, e.g., as described below.

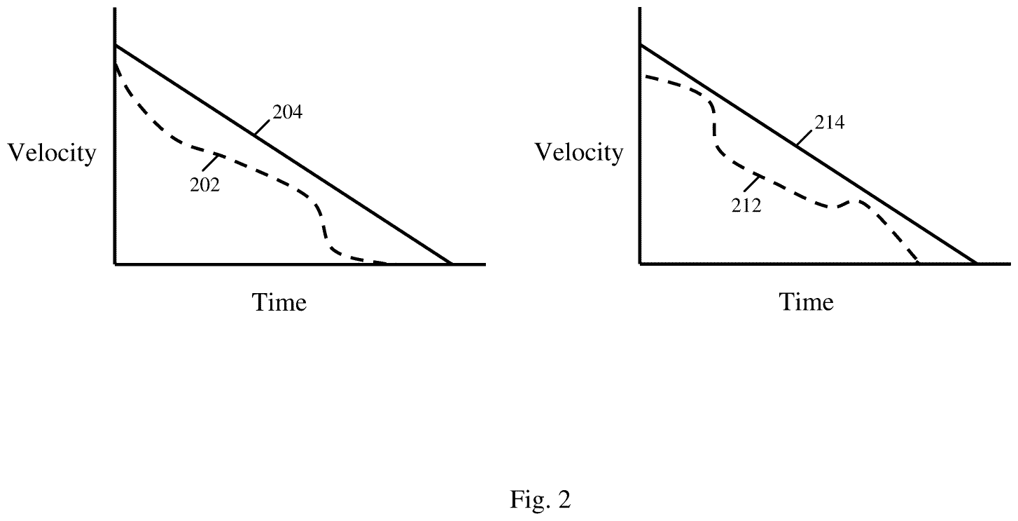

Reference is made to FIG. 2, which schematically illustrates a rotational velocity profile 202 corresponding to a first wheel of a mobile robot, and a rotational velocity profile 212 corresponding to a second wheel of the mobile robot, to illustrate one or more technical aspects, which may be handled in accordance with some demonstrative aspects.

For example, as shown in FIG. 2, when implementing a safety stop for a wheel according to an SS1 function, it may be required to ensure that the actual velocity of the wheel is maintained under a specific curve over time, e.g., until the wheel reaches a zero velocity.

For example, as shown in FIG. 2, when implementing a safety stop for a first wheel according to an SS1 function, it may be required to ensure that the actual velocity 202 of the first wheel is maintained under a specific curve 204 over time, e.g., until the first wheel reaches a zero velocity.

For example, as shown in FIG. 2, when implementing a safety stop for a second wheel according to an SS1 function, it may be required to ensure that the actual velocity 212 of the second wheel is maintained under a specific curve 214 over time, e.g., until the first wheel reaches a zero velocity.

In one example, as shown in FIG. 2, the curves 204 and 214 may be different.

In another example, the curves 204 and 214 may be similar to one another, or may include substantially the same curve.

In some demonstrative aspects, for example, in case of multiple wheels that are dependent on each other, it may not be sufficient to ensure that the velocity of each wheel is below a corresponding decreasing curve.

In some demonstrative aspects, for example, in case of multiple wheels that are dependent on each other, there may be a need to ensure that the velocity of a wheel, e.g., of each wheel, is maintained over a minimal value, which may be dependent on the velocity of one or more, e.g., some or all, other wheels.

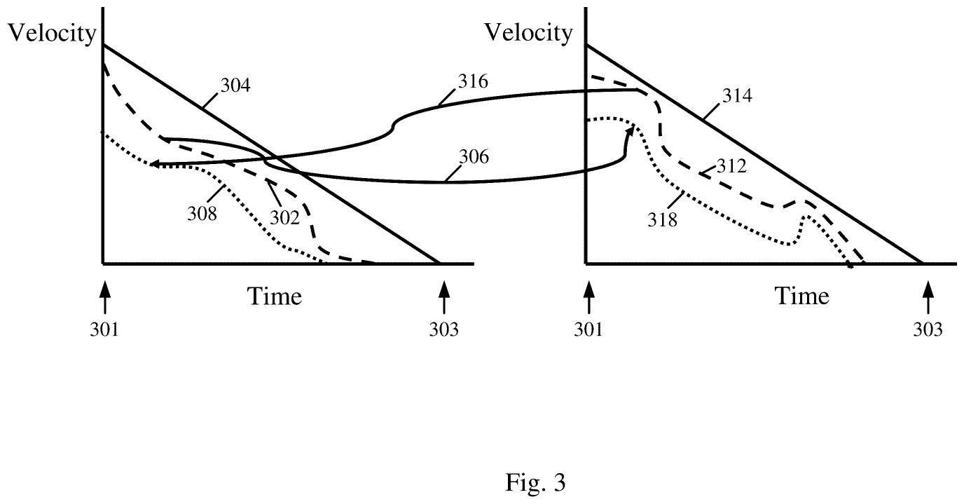

Reference is made to FIG. 3, which schematically illustrates a rotational velocity profile 302 corresponding to a first wheel of a mobile robot, and a rotational velocity profile 312 corresponding to a second wheel of the mobile robot, in accordance with some demonstrative aspects.

For example, controller 150 (FIG. 1) may configure the control signal 171 (FIG. 1) to control the velocity of the first wheel 132 (FIG. 1), e.g., according to the rotational velocity profile 302.

For example, controller 150 (FIG. 1) may configure the control signal 173 (FIG. 1) to control the velocity of the second wheel 134 (FIG. 1), e.g., according to the rotational velocity profile 312.

For example, controller 150 (FIG. 1) may configure the first rotational velocity profile 302 and the second rotational velocity profile 312, for example, to maintain the controlled trajectory of the mobile robot 100 (FIG. 1) during the controlled safety stop, e.g., as described above.

In some demonstrative aspects, as shown in FIG. 3, the first rotational velocity profile 302 may be non-linear.

In some demonstrative aspects, as shown in FIG. 3, the second rotational velocity profile 312 may be non-linear.

In some demonstrative aspects, as shown in FIG. 3, the first rotational velocity profile 302 may be different from the second rotational velocity profile 312, e.g., as described below.

In some demonstrative aspects, as shown in FIG. 3, the rotational velocity profile 302 may be configured to be between an upper bound 304 for the rotational velocity profile 302 and a lower bound 308 for the rotational velocity profile 302.

In some demonstrative aspects, as shown in FIG. 3, the upper bound 304 for the rotational velocity profile 302 may be monotonously decreasing between a first time 301 of the controlled safety stop and a second time 303 of the controlled safety stop.

In some demonstrative aspects, as shown in FIG. 3, the lower bound 308 for the rotational velocity profile 302 may represent a minimal value for the rotational velocity profile 302.

In some demonstrative aspects, as indicated by arrow 316 the lower bound 308 for the rotational velocity profile 302 may change, for example, according to a state of the rotational velocity profile 312.

In some demonstrative aspects, as indicated by arrow 316 the lower bound 308 for the rotational velocity profile 302 may depend on, and/or may be adjusted based on, the rotational velocity profile 312, e.g., as described below.

For example, controller 150 (FIG. 1) may be configured to adjust the lower bound 308 for the rotational velocity profile 302 for the first wheel 132 (FIG. 1), for example, based on the rotational velocity profile 312 corresponding to the rotational velocity of the second wheel 134 (FIG. 1).

For example, controller 150 (FIG. 1) may be configured to adjust the lower bound 308 for the rotational velocity profile 302 for the first wheel 132 (FIG. 1), for example, based on a change (316) in the rotational velocity profile 312 corresponding to the rotational velocity of the second wheel 134 (FIG. 1).

In some demonstrative aspects, as shown in FIG. 3, the rotational velocity profile 312 may be configured to be between an upper bound 314 for the rotational velocity profile 312 and a lower bound 318 for the rotational velocity profile 312.

In some demonstrative aspects, as shown in FIG. 3, the upper bound 314 for the rotational velocity profile 312 may be monotonously decreasing between the first time 301 of the controlled safety stop and the second time 303 of the controlled safety stop.

In some demonstrative aspects, as shown in FIG. 3, the lower bound 318 for the rotational velocity profile 312 may represent a minimal value for the rotational velocity profile 312.

In some demonstrative aspects, as indicated by arrow 306 the lower bound 318 for the rotational velocity profile 312 may change, for example, according to a state of the rotational velocity profile 302.

In some demonstrative aspects, as indicated by arrow 306 the lower bound 318 for the rotational velocity profile 312 may depend on, and/or may be adjusted based on, the rotational velocity profile 302, e.g., as described below.

For example, controller 150 (FIG. 1) may be configured to adjust the lower bound 318 for the rotational velocity profile 312 for the second wheel 134 (FIG. 1), for example, based on the rotational velocity profile 302 corresponding to the rotational velocity of the first wheel 132 (FIG. 1).

For example, controller 150 (FIG. 1) may be configured to adjust the lower bound 318 for the rotational velocity profile 312 for the second wheel 134 (FIG. 1), for example, based on a change (306) in the rotational velocity profile 302 corresponding to the rotational velocity of the first wheel 132 (FIG. 1).

In some demonstrative aspects, the relationship between the rotational velocity profile 302 and the rotational velocity profile 312, e.g., the adjustment (316) of the rotational velocity profile 302 based on the rotational velocity profile 312 and/or the adjustment (306) of the rotational velocity profile 312 based on the rotational velocity profile 302, may depend on a use case and/or implementation.

For example, in one case a mobile robot, e.g., mobile robot 100 (FIG. 1), may utilize two wheels, which may be controlled during a controlled safety stop, e.g., as described above. For example, in case the mobile robot is driving in a non-linear trajectory, e.g., a trajectory having a radius, it may be required to ensure that a wheel, e.g., each wheel, of the mobile robot reduces its speed while taking into consideration the velocity of the other wheel, for example, in order to substantially maintain the radius of the trajectory.

For example, this requirement may be in contrast to implementation of the STO or SS1 function, where each wheel may be decelerated as fast as possible without any consideration of the other wheels.

In some demonstrative aspects, as shown in FIG. 3, the velocity profile 302 and the velocity profile 312 may be configured, while adhering to the upper bound 304 and the upper bound 314, and while dynamically changing (316) the lower bund 308 based on the velocity 312 and dynamically changing (306) the lower bund 318 based on the velocity 312. For example, this adjustment of the lower bund 308 and the lower bund 318 may provide a technical solution to maintain the driving radius of the mobile robot substantially the same, e.g., as much as possible.

In some demonstrative aspects, a monitored trajectory radius of the mobile robot may be determined based on the plurality of monitored rotational velocities of the wheels of the mobile robot.

For example, in case of two wheels, e.g., wheel 132 (FIG. 1) and wheel 134 (FIG. 1), the monitored trajectory radius of the mobile robot, e.g., mobile robot 100 (FIG. 1), may be determined, for example, based on a linear velocity and an angular velocity corresponding to the mobile robot, e.g., as described below.

For example, the linear velocity corresponding to the mobile robot may be determined, e.g., as follows:

$${L}_{V} = \frac{( {ω}_{r} {R}_{r} + {ω}_{l} {R}_{l} )}{2} \qquad ( 1 )$$

wherein L_{V} denotes the linear velocity;
wherein ωᵣ denotes a rotational velocity of a first wheel, e.g., a righthand wheel, for example, wheel 132 (FIG. 1);
wherein wₗ denotes a rotational velocity of a second wheel, e.g., a lefthand wheel, for example, wheel 134 (FIG. 1);
wherein Rᵣ denotes a radius of the first wheel; and
wherein Rₗ denotes a radius of the second wheel.

For example, the angular velocity corresponding to the mobile robot may be determined, e.g., as follows:

$${A}_{V} = \frac{( {ω}_{r} {R}_{r} - {ω}_{l} {R}_{l} )}{l} \qquad ( 2 )$$

wherein l denotes a distance between the center of the first wheel and the center of the second wheel.

For example, the monitored trajectory radius of the mobile robot, denoted Radius, may be determined, e.g., as follows:

$$Radius = \frac{{L}_{V}}{{A}_{V}} = \frac{( {ω}_{r} {R}_{r} + {ω}_{l} {R}_{l} ) * l}{( {ω}_{r} {R}_{r} - {ω}_{l} {R}_{l} ) * 2} \qquad ( 3 )$$

In some demonstrative aspects, a controller of a mobile robot, e.g., the controller 150 (FIG. 1) of the mobile robot 100 (FIG. 1), may be configured to configure a first control output, e.g., control output 171 (FIG. 1), to control an actuator of a first wheel, e.g., actuator 162 (FIG. 1) of wheel 132 (FIG. 1), and to configure a second control output, e.g., control output 173 (FIG. 1), to control an actuator of a second wheel, e.g., actuator 164 (FIG. 1) of wheel 134 (FIG. 1), for example, based on a monitored trajectory radius of the mobile robot, e.g., the value of Radius according to Equation 3.

For example, the controller of the mobile robot, e.g., controller 150 (FIG. 1), may configure the first control output, e.g., control output 171 (FIG. 1), and the second control output, e.g., control output 173 (FIG. 1), for example, to substantially maintain the value of Radius substantially constat, e.g., such that the radius of the trajectory of the mobile robot may remain substantially unchanged during the controlled safety stop.

For example, the controller of the mobile robot, e.g., controller 150 (FIG. 1), may configure the first control output, e.g., control output 171 (FIG. 1), to adjust the rotational velocity ωᵣ, and the second control output, e.g., control output 173 (FIG. 1), to adjust the rotational velocity ωᵣ, for example, such that the value of Radius, e.g., according to Equation 3, may be maintained substantially constat.

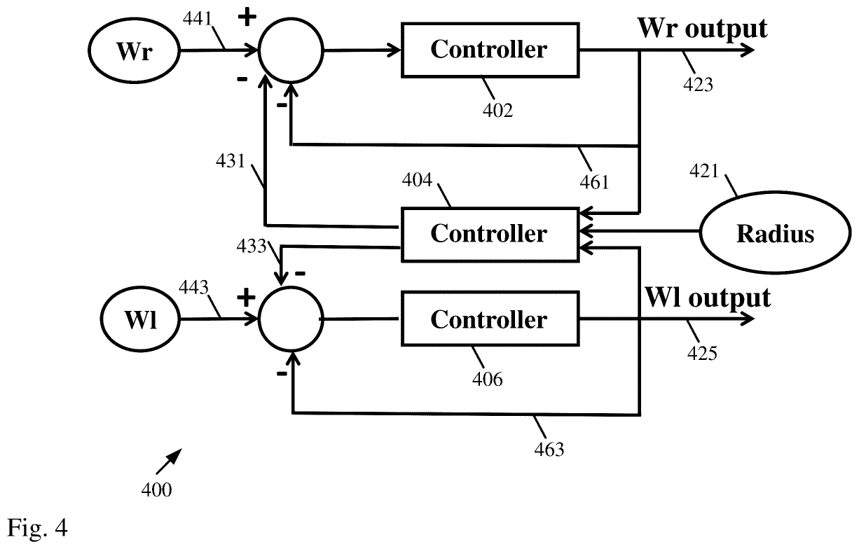

Reference is made to FIG. 4, which schematically illustrates an architecture of a controller 400, in accordance with some demonstrative aspects.

For example, controller 150 (FIG. 1) may include one or more components of controller 400, and/or may perform one or more operations and/or functionalities of controller 400.

In some demonstrative aspects, controller 400 may be configured according to an open loop control scheme, a closed-loop control scheme, a Proportional-Integral-Derivative (PID) control scheme, an optimal control scheme, an adaptive control scheme, and/or any other suitable additional or alternative control scheme.

In some demonstrative aspects, controller 400 may be configured to support control of two wheels, e.g., as described below.

In other aspects, controller 400 may be configured to support control of any other number of wheels, e.g., three wheels, four wheels, or more.

In some demonstrative aspects, controller 400 may be configured to control a rotational velocity of a first wheel according to a first desired rotational velocity, denoted Wr, and to control a the rotational velocity of a second wheel according to a second desired rotational velocity, denoted Wl.

In some demonstrative aspects, controller 400 may include a first controller 402, which may be configured to provide a first control output to control the rotational velocity of the first wheel, e.g., the rotational velocity ωᵣ. For example, the control output 171 (FIG. 1) may include, or may be based on the first control output provided by the first controller 402.

In some demonstrative aspects, controller 400 may include a second controller 406, which may be configured to provide a second control output to control the rotational velocity of the second wheel, e.g., the rotational velocity ωₗ. For example, the control output 173 (FIG. 1) may include, or may be based on the second control output provided by the second controller 406.

In some demonstrative aspects, controller 400 may include a third controller 404, which may be configured to determine an adjustment 431 to be applied to an input of controller 402, e.g., as described below.

In some demonstrative aspects, controller 404 may be configured to determine the adjustment 431, for example, based on a monitored rotational velocity 423 of the first wheel, denoted Wr output, a monitored rotational velocity 425 of the second wheel, denoted Wl output, and a controlled trajectory radius 421 of the mobile robot, e.g., a desired value or a target value of Radius.

For example, the monitored rotational velocity 423 may include, or may be based on, the velocity information 167 (FIG. 1) provided by the sensor 166 (FIG. 1) with respect to the wheel 132 (FIG. 1).

For example, the monitored rotational velocity 425 may include, or may be based on, the velocity information 169 (FIG. 1) provided by the sensor 168 (FIG. 1) with respect to the wheel 134 (FIG. 1).

In some demonstrative aspects, controller 404 may be configured to determine the adjustment 433, for example, based on the monitored rotational velocity 423 of the first wheel, the monitored rotational velocity 425 of the second wheel, and the controlled trajectory radius 421 of the mobile robot.

For example, controller 404 may be configured to determine a current monitored trajectory radius of the mobile robot, for example, based on the monitored rotational velocity 423 of the first wheel and the monitored rotational velocity 425 of the second wheel.

For example, controller 404 may be configured to determine the adjustment 431 and/or the adjustment 433, for example, based on a comparison between the determined current monitored trajectory radius of the mobile robot and the controlled trajectory radius 421.

For example, controller 404 may be configured to determine the adjustment 431 and/or the adjustment 433, for example, in accordance with Equation 3, for example, such that a difference between the determined current monitored trajectory radius of the mobile robot and the controlled trajectory radius 421 is to be reduced, e.g., minimized.

For example, as shown in FIG. 4, controller 400 may determine a first first-wheel adjustment 461, for example, based on the rotational velocity 423 of the first wheel.

For example, as shown in FIG. 4, controller 400 may determine a second first-wheel adjustment, e.g., the adjustment 431, for example, based on the rotational velocity 423 of the first wheel, the rotational velocity 425 of the second wheel, and the radius 421 of the controlled trajectory.

For example, as shown in FIG. 4, controller 400 may be configured to adjust the first control output, e.g., the output of the controller 402, for example, based on the first first-wheel adjustment 461 and the second first-wheel adjustment 431.

For example, as shown in FIG. 4, controller 400 may determine a first second-wheel adjustment 463, for example, based on the rotational velocity 425 of the second wheel.

For example, as shown in FIG. 4, controller 400 may determine a second second-wheel adjustment, e.g., the adjustment 433, for example, based on the rotational velocity 423 of the first wheel, the rotational velocity 425 of the second wheel, and the radius 421 of the controlled trajectory.

For example, as shown in FIG. 4, controller 400 may be configured to adjust the second control output, e.g., the output of the controller 406, for example, based on the first second-wheel adjustment 463 and the second second-wheel adjustment 433.

In some demonstrative aspects, controller 400 may implement one or more predefined and/or preconfigured tables, e.g., a hashing table and/or any other suitable table, for example, to store pre-calculated values for the first desired rotational velocity Wr and/or the second desired rotational velocity WI, for example, with respect to a plurality of possible values of the trajectory-radius Radius, e.g., in accordance with Equation 3. For example, the precalculated values may be utilized to provide a technical solution with reduced computational load and/or reduced computational time, e.g., even for a larger number of controlled wheels.

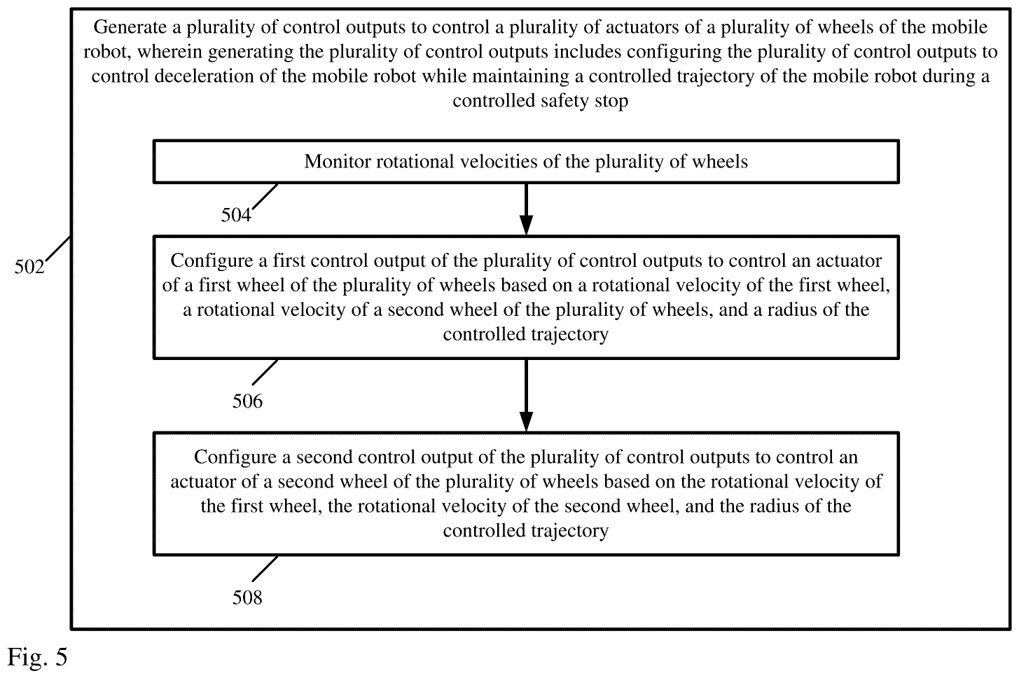

Reference is made to FIG. 5, which schematically illustrates a method of a mobile robot controlled safety-stop, in accordance with some demonstrative aspects. For example, one or more of the operations of the method of FIG. 5 may be performed by one or more elements of a mobile robot, e.g., mobile robot 100 (FIG. 1), for example, a controller, e.g., controller 150 (FIG. 1), and/or controller 400 (FIG. 4), and/or a processor, e.g., processor 152 (FIG. 1).

In some demonstrative aspects, as indicated at block 502, the method may include generating a plurality of control outputs to control a plurality of actuators of a plurality of wheels of the mobile robot. For example, generating the plurality of control outputs may include configuring the plurality of control outputs to control deceleration of the mobile robot while maintaining a controlled trajectory of the mobile robot during a controlled safety stop. For example, controller 150 (FIG. 1) may be configured to generate the control outputs 171 (FIG. 1), 173 (FIG. 1), 175 (FIG. 1), 176 (FIG. 1), 177 (FIG. 1), and/or 178 (FIG. 1), for example, to control deceleration of the mobile robot 100 (FIG. 1) while maintaining a controlled trajectory of the mobile robot during a controlled safety stop, e.g., as described above.

In some demonstrative aspects, as indicated at block 504, generating the plurality of control outputs may include monitoring rotational velocities of the plurality of wheels. For example, controller 150 (FIG. 1) may be configured to monitor the rotational velocities of the plurality of wheels of mobile robot 100 (FIG. 1), e.g., as described above.

In some demonstrative aspects, as indicated at block 506, generating the plurality of control outputs may include configuring a first control output of the plurality of control outputs to control an actuator of a first wheel of the plurality of wheels based, for example, on a rotational velocity of the first wheel, a rotational velocity of a second wheel of the plurality of wheels, and a radius of the controlled trajectory. For example, controller 150 (FIG. 1) may configure the control output 171 (FIG. 1) to control actuator 162 (FIG. 1) of the first wheel 132 (FIG. 1) based, for example, on the rotational velocity of the first wheel 132 (FIG. 1), the rotational velocity of the second wheel 134 (FIG. 1), and the radius of the controlled trajectory, e.g., as described above.

In some demonstrative aspects, as indicated at block 508, generating the plurality of control outputs may include configuring a second control output of the plurality of control outputs to control an actuator of a second wheel of the plurality of wheels based, for example, on the rotational velocity of the first wheel, the rotational velocity of the second wheel, and the radius of the controlled trajectory. For example, controller 150 (FIG. 1) may configure the control output 173 (FIG. 1) to control actuator 164 (FIG. 1) of the second wheel 134 (FIG. 1) based, for example, on the rotational velocity of the first wheel 132 (FIG. 1), the rotational velocity of the second wheel 134 (FIG. 1), and the radius of the controlled trajectory, e.g., as described above.

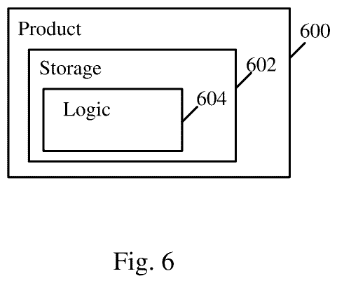

Reference is made to FIG. 6, which schematically illustrates a product of manufacture 600, in accordance with some demonstrative aspects. Product 600 may include one or more tangible computer-readable (“machine-readable”) non-transitory storage media 602, which may include computer-executable instructions, e.g., implemented by logic 604, operable to, when executed by at least one processor, enable the at least one processor to implement one or more operations at a mobile robot, e.g., mobile robot 100 (FIG. 1), a controller, e.g., controller 150 (FIG. 1), and/or controller 400 (FIG. 4), and/or a processor, e.g., processor 152 (FIG. 1); to cause a mobile robot, e.g., mobile robot 100 (FIG. 1), a controller, e.g., controller 150 (FIG. 1), and/or controller 400 (FIG. 4), and/or a processor, e.g., processor 152 (FIG. 1), to perform, trigger and/or implement one or more operations and/or functionalities; and/or to perform, trigger and/or implement one or more operations and/or functionalities described with reference to the FIGS. 1-5, and/or one or more operations described herein. The phrases “non-transitory machine-readable medium” and “computer-readable non-transitory storage media” may be directed to include all machine and/or computer readable media, with the sole exception being a transitory propagating signal.

In some demonstrative aspects, product 600 and/or machine readable storage media 602 may include one or more types of computer-readable storage media capable of storing data, including volatile memory, non-volatile memory, removable or non-removable memory, erasable or non-erasable memory, writeable or re-writeable memory, and the like. For example, machine readable storage media 602 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), flash memory (e.g., NOR or NAND flash memory), content addressable memory (CAM), polymer memory, phase-change memory, ferroelectric memory, silicon-oxide-nitride-oxide-silicon (SONOS) memory, a disk, a hard drive, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative aspects, logic 604 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative aspects, logic 604 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, machine code, and the like.

### EXAMPLES

The following examples pertain to further aspects.

Example 1 includes an apparatus for a mobile robot, the apparatus comprising a controller configured to generate a plurality of control outputs to control a plurality of actuators of a plurality of wheels of the mobile robot, wherein the controller is to configure the plurality of control outputs to control deceleration of the mobile robot while maintaining a controlled trajectory of the mobile robot during a controlled safety stop, wherein during the controlled safety stop the controller is to monitor rotational velocities of the plurality of wheels; configure a first control output of the plurality of control outputs to control an actuator of a first wheel of the plurality of wheels based on a rotational velocity of the first wheel, a rotational velocity of a second wheel of the plurality of wheels, and a radius of the controlled trajectory; and configure a second control output of the plurality of control outputs to control an actuator of a second wheel of the plurality of wheels based on the rotational velocity of the first wheel, the rotational velocity of the second wheel, and the radius of the controlled trajectory; and an output to output an output based on the plurality of control outputs.

Example 2 includes the subject matter of Example 1, and optionally, wherein the controller is to configure the first control output and the second control output based on a monitored trajectory radius of the mobile robot, the monitored trajectory radius of the mobile robot based on the rotational velocity of the first wheel and the rotational velocity of the second wheel.

Example 3 includes the subject matter of Example 2, and optionally, wherein the controller is to configure the first control output and the second control output based on a difference between the radius of the controlled trajectory and the monitored trajectory radius of the mobile robot.

Example 4 includes the subject matter of Example 2 or 3, and optionally, wherein the controller is configured to determine the monitored trajectory radius of the mobile robot based on a ratio between a linear velocity sum and a linear velocity difference, the linear velocity sum comprising a sum of a linear velocity of the first wheel and a linear velocity of the second wheel, the linear velocity difference comprising a difference between the linear velocity of the first wheel and the linear velocity of the second wheel.

Example 5 includes the subject matter of Example 4, and optionally, wherein the controller is configured to determine the linear velocity of the first wheel based on the rotational velocity of the first wheel, and the linear velocity of the second wheel based on the rotational velocity of the second wheel.

Example 6 includes the subject matter of any one of Examples 1-5, and optionally, wherein the controller is to configure the first control output to control the rotational velocity of the first wheel according to a first rotational velocity profile, and to configure the second control output to control the rotational velocity of the second wheel according to a second rotational velocity profile, wherein the first rotational velocity profile and the second rotational velocity profile are configured to maintain the controlled trajectory of the mobile robot during the controlled safety stop.

Example 7 includes the subject matter of Example 6, and optionally, wherein at least one profile of the first rotational velocity profile or the second rotational velocity profile is non-linear.

Example 8 includes the subject matter of Example 6 or 7, and optionally, wherein the first velocity profile is different from the second velocity profile.

Example 9 includes the subject matter of any one of Examples 6-8, and optionally, wherein the controller is to configure the first rotational velocity profile between an upper bound for the first rotational velocity profile and a lower bound for the first rotational velocity profile, wherein the upper bound for first rotational velocity profile is monotonously decreasing from a first time of the controlled safety stop to a second time of the controlled safety stop, wherein the controller is configured to adjust the lower bound for the first rotational velocity profile between the first time and the second time based on the rotational velocity of the second wheel.

Example 10 includes the subject matter of any one of Examples 6-9, and optionally, wherein the controller is to configure the second rotational velocity profile between an upper bound for the second rotational velocity profile and a lower bound for the second rotational velocity profile, wherein the upper bound for second rotational velocity profile is monotonously decreasing from a first time of the controlled safety stop to a second time of the controlled safety stop, wherein the controller is configured to adjust the lower bound for the second rotational velocity profile between the first time and the second time based on the rotational velocity of the first wheel.

Example 11 includes the subject matter of any one of Examples 1-10, and optionally, wherein the controller is configured to determine a first first-wheel adjustment based on the rotational velocity of the first wheel; determine a second first-wheel adjustment based on the rotational velocity of the first wheel, the rotational velocity of the second wheel, and the radius of the controlled trajectory; and adjust the first control output based on the first first-wheel adjustment and the second first-wheel adjustment.

Example 12 includes the subject matter of any one of Examples 1-11, and optionally, wherein the controller is configured to determine a first second-wheel adjustment based on the rotational velocity of the second wheel; determine a second second-wheel adjustment based on the rotational velocity of the first wheel, the rotational velocity of the second wheel, and the radius of the controlled trajectory; and adjust the second control output based on the first second-wheel adjustment and the second second-wheel adjustment.

Example 13 includes the subject matter of any one of Examples 1-12, and optionally, wherein the plurality of wheels comprises at least a third wheel, wherein during the controlled safety stop the controller is to configure at least one control output of the first control output or the second control output based on a rotational velocity of the third wheel.

Example 14 includes the subject matter of any one of Examples 1-13, and optionally, wherein the controller is configured to determine the radius of the controlled trajectory based on a radius of a trajectory of the mobile robot prior to the controlled safety stop.

Example 15 includes the subject matter of any one of Examples 1-14, and optionally, wherein the controller is to configure the plurality of control outputs to maintain the controlled trajectory of the mobile robot during the controlled safety stop to be substantially constant and substantially equal to a radius of a trajectory of the mobile robot prior to the controlled safety stop.

Example 16 includes the subject matter of any one of Examples 1-14, and optionally, wherein the radius of the controlled trajectory comprises a predefined radius for the controlled safety stop.

Example 17 includes the subject matter of any one of Examples 1-14, and optionally, wherein the controller is configured to determine the radius of the controlled trajectory based on a radius of a predefined trajectory for the controlled safety stop.

Example 18 includes the subject matter of any one of Examples 1-17, and optionally, wherein the controlled safety stop comprises a category 1 deceleration-controlled safety stop (SS1-d).

Example 19 includes the subject matter of any one of Examples 1-18, and optionally, wherein the controller is configured to trigger the controlled safety stop based on a safety event detection, the safety event detection based on information from one or more sensors of the mobile robot.

Example 20 comprises an apparatus comprising means for executing any of the described operations of Examples 1-19.

Example 21 comprises a controller configured to perform any of the described operations of Examples 1-19.

Example 22 comprises a mobile robot configured to perform any of the described operations of Examples 1-19.

Example 23 comprises a product comprising one or more tangible computer-readable non-transitory storage media comprising instructions operable to, when executed by at least one processor, enable the at least one processor to cause any of the described operations of Examples 1-19.

Example 24 comprises an apparatus comprising: a memory interface; and processing circuitry configured to: perform any of the described operations of Examples 1-19.

Example 25 comprises a method comprising any of the described operations of Examples 1-19.

Functions, operations, components and/or features described herein with reference to one or more aspects, may be combined with, or may be utilized in combination with, one or more other functions, operations, components and/or features described herein with reference to one or more other aspects, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the disclosure.

What is claimed is:

1. An apparatus for a mobile robot, the apparatus comprising:
a controller configured to generate a plurality of control outputs to control a plurality of actuators of a plurality of wheels of the mobile robot, wherein the controller is to configure the plurality of control outputs to control deceleration of the mobile robot while maintaining a controlled trajectory of the mobile robot during a controlled safety stop, wherein during the controlled safety stop the controller is to:
monitor rotational velocities of the plurality of wheels;
configure a first control output of the plurality of control outputs to control an actuator of a first wheel of the plurality of wheels based on a rotational velocity of the first wheel, a rotational velocity of a second wheel of the plurality of wheels, and a radius of the controlled trajectory; and
configure a second control output of the plurality of control outputs to control an actuator of a second wheel of the plurality of wheels based on the rotational velocity of the first wheel, the rotational velocity of the second wheel, and the radius of the controlled trajectory; and
an output to output a controller output based on the plurality of control outputs.

2. The apparatus of claim 1, wherein the controller is to configure the first control output and the second control output based on a monitored trajectory radius of the mobile robot, the monitored trajectory radius of the mobile robot based on the rotational velocity of the first wheel and the rotational velocity of the second wheel.

3. The apparatus of claim 2, wherein the controller is to configure the first control output and the second control output based on a difference between the radius of the controlled trajectory and the monitored trajectory radius of the mobile robot.

4. The apparatus of claim 2, wherein the controller is configured to determine the monitored trajectory radius of the mobile robot based on a ratio between a linear velocity sum and a linear velocity difference, the linear velocity sum comprising a sum of a linear velocity of the first wheel and a linear velocity of the second wheel, the linear velocity difference comprising a difference between the linear velocity of the first wheel and the linear velocity of the second wheel.

5. The apparatus of claim 4, wherein the controller is configured to determine the linear velocity of the first wheel based on the rotational velocity of the first wheel, and the linear velocity of the second wheel based on the rotational velocity of the second wheel.

6. The apparatus of claim 1, wherein the controller is to configure the first control output to control the rotational velocity of the first wheel according to a first rotational velocity profile, and to configure the second control output to control the rotational velocity of the second wheel according to a second rotational velocity profile, wherein the first rotational velocity profile and the second rotational velocity profile are configured to maintain the controlled trajectory of the mobile robot during the controlled safety stop.

7. The apparatus of claim 6, wherein at least one profile of the first rotational velocity profile or the second rotational velocity profile is non-linear.

8. The apparatus of claim 6, wherein the first velocity profile is different from the second velocity profile.

9. The apparatus of claim 6, wherein the controller is to configure the first rotational velocity profile between an upper bound for the first rotational velocity profile and a lower bound for the first rotational velocity profile, wherein the upper bound for first rotational velocity profile is monotonously decreasing from a first time of the controlled safety stop to a second time of the controlled safety stop, wherein the controller is configured to adjust the lower bound for the first rotational velocity profile between the first time and the second time based on the rotational velocity of the second wheel.

10. The apparatus of claim 6, wherein the controller is to configure the second rotational velocity profile between an upper bound for the second rotational velocity profile and a lower bound for the second rotational velocity profile, wherein the upper bound for second rotational velocity profile is monotonously decreasing from a first time of the controlled safety stop to a second time of the controlled safety stop, wherein the controller is configured to adjust the lower bound for the second rotational velocity profile between the first time and the second time based on the rotational velocity of the first wheel.

11. The apparatus of claim 1, wherein the controller is configured to:
determine a first first-wheel adjustment based on the rotational velocity of the first wheel;
determine a second first-wheel adjustment based on the rotational velocity of the first wheel, the rotational velocity of the second wheel, and the radius of the controlled trajectory; and
adjust the first control output based on the first first-wheel adjustment and the second first-wheel adjustment.

12. The apparatus of claim 11, wherein the controller is configured to:
determine a first second-wheel adjustment based on the rotational velocity of the second wheel;
determine a second second-wheel adjustment based on the rotational velocity of the first wheel, the rotational velocity of the second wheel, and the radius of the controlled trajectory; and
adjust the second control output based on the first second-wheel adjustment and the second second-wheel adjustment.

13. The apparatus of claim 1, wherein the plurality of wheels comprises at least a third wheel, wherein during the controlled safety stop the controller is to configure at least one control output of the first control output or the second control output based on a rotational velocity of the third wheel.

14. The apparatus of claim 1, wherein the controller is configured to determine the radius of the controlled trajectory based on a radius of a trajectory of the mobile robot prior to the controlled safety stop.

15. The apparatus of claim 1, wherein the controller is to configure the plurality of control outputs to maintain the controlled trajectory of the mobile robot during the controlled safety stop to be substantially constant and substantially equal to a radius of a trajectory of the mobile robot prior to the controlled safety stop.

16. The apparatus of claim 1, wherein the controller is configured to determine the radius of the controlled trajectory based on a radius of a predefined trajectory for the controlled safety stop.

17. The apparatus of claim 1, wherein the controlled safety stop comprises a category 1 deceleration-controlled safety stop (SS1-d).

18. The apparatus of claim 1, wherein the controller is configured to trigger the controlled safety stop based on a safety event detection, the safety event detection based on information from one or more sensors of the mobile robot.

19. A product comprising one or more tangible computer-readable non-transitory storage media comprising instructions operable to, when executed by at least one processor, enable the at least one processor to cause a controller of a mobile robot to:
generate a plurality of control outputs to control a plurality of actuators of a plurality of wheels of the mobile robot, the plurality of control outputs to control deceleration of the mobile robot while maintaining a controlled trajectory of the mobile robot during a controlled safety stop,
wherein, the instructions, when executed, cause the controller to, during the controlled safety stop:
monitor rotational velocities of the plurality of wheels;
configure a first control output of the plurality of control outputs to control an actuator of a first wheel of the plurality of wheels based on a rotational velocity of the first wheel, a rotational velocity of a second wheel of the plurality of wheels, and a radius of the controlled trajectory; and
configure a second control output of the plurality of control outputs to control an actuator of a second wheel of the plurality of wheels based on the rotational velocity of the first wheel, the rotational velocity of the second wheel, and the radius of the controlled trajectory.

20. The product of claim 19, wherein the instructions, when executed, cause the controller to configure the first control output and the second control output based on a monitored trajectory radius of the mobile robot, the monitored trajectory radius of the mobile robot based on the rotational velocity of the first wheel and the rotational velocity of the second wheel.
